(19) United States
(12) Patent Application Publication
(10) Pub. No.: US 2008/0289656 A1
(43) Pub. Date: Nov. 27, 2008

(54) SUBSTRATE PROCESSING METHOD AND SUBSTRATE PROCESSING APPARATUS

(76) Inventor: Takehiro KONDOH, Yokkaichi-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/126,087

(22) Filed: May 23, 2008

(30) Foreign Application Priority Data
May 25, 2007 (JP) 2007-138933

(51) Int. Cl. B08B 7/00; B08B 13/00

(52) U.S. Cl. 134/18; 134/56 R

(57) ABSTRACT

According to one aspect of the present invention, there is provided a substrate processing method of drying a substrate to be processed by rotating the substrate while supplying a cleaning solution onto a surface of the substrate, the method comprising, when moving, on the substrate, a cleaning solution supply position where the cleaning solution is supplied on the surface of the substrate in rotation, measuring a water level in a predetermined portion on the surface of the substrate in at least a partial region on the surface of the substrate, and controlling based on the measured water level at least one of a cleaning solution supply position moving velocity when moving the position where the cleaning solution is supplied and a rotational speed of the substrate.

### CROSS REFERENCE TO RELATED APPLICATION

This application is based upon and claims benefit of priority under 35 USC §119 from the Japanese Patent Application No. 2007-138933, filed on May 25, 2007, the entire contents of which are incorporated herein by reference.

### BACKGROUND OF THE INVENTION

The present invention relates to a substrate processing method and substrate processing apparatus.

Substrates must be cleaned in wet processing steps in the fabrication of, e.g., semiconductor devices, LSIs, electronic circuit parts, and liquid crystal display elements, particularly, in a process using a photosensitive resist film. Recently, as the diameters of substrates increase, a fatal defect caused by insufficient cleaning has become a serious problem in a photosensitive resist film cleaning step, e.g., in a rinsing step of a developing process or in a cleaning step of a liquid dipping process.

Conventionally, cleaning and drying are performed by supplying a cleaning solution from a nozzle in a fixed position while rotating a substrate. In this method, however, a turbulence generated by the increase in diameter in the outer periphery of a substrate advances drying faster in the outer peripheral portion than in the central portion of the substrate. Consequently, a substance removed by cleaning from the central portion remains in the outer peripheral portion of the substrate.

To solve this problem, as described in patent reference 1 (to be described later), a cleaning method has been proposed in which a cleaning solution is supplied to the center of a substrate in rotation in the initial stages of a cleaning step, and a nozzle is moved from the center to the outer periphery of the substrate.

However, it is difficult for this method to optimize nozzle movement control. Even if the control is optimized by trial and error in a specific cleaning step, an optimum solution changes whenever the material of a photosensitive resist changes. Therefore, the control must be optimized for each material, and this deteriorates the workability.

Japanese Patent Laid-Open No. 2006-80315

### SUMMARY OF THE INVENTION

According to one aspect of the present invention, there is provided a substrate processing method of drying a substrate to be processed by rotating the substrate while supplying a cleaning solution onto a surface of the substrate, the method comprising, when moving, on the substrate, a cleaning solution supply position where the cleaning solution is supplied on the surface of the substrate in rotation, measuring a water level in a predetermined portion on the surface of the substrate in at least a partial region on the surface of the substrate, and controlling based on the measured water level at least one of a cleaning solution supply position moving velocity when moving the position where the cleaning solution is supplied and a rotational speed of the substrate.

According to one aspect of the present invention, there is provided a substrate processing apparatus for drying a substrate to be processed by rotating the substrate while supplying a cleaning solution onto a surface of the substrate, the apparatus comprising: a substrate holding/rotating unit configured to hold and rotate the substrate; a cleaning solution supply unit configured to supply the cleaning solution onto the surface of the substrate in rotation while moving over the substrate; a measuring unit configured to measure a water level of the cleaning solution on the surface of the substrate; and a controller configured to control at least one of a cleaning solution supply position moving velocity and a rotational speed of the substrate on the basis of the water level of the cleaning solution measured in at least a partial region on the surface of the substrate.

According to one aspect of the present invention, there is provided a substrate processing apparatus for drying a substrate to be processed by rotating the substrate while supplying a cleaning solution onto a surface of the substrate, the apparatus comprising: a substrate holding/rotating unit configured to hold and rotate the substrate; a cleaning solution supply unit configured to supply the cleaning solution onto the surface of the substrate in rotation while moving over the substrate; a storage unit configured to store premeasured data concerning a change in water level of the cleaning solution when cleaning a predetermined film formed on the substrate; and a controller configured to control at least one of a cleaning solution supply position moving velocity and a rotational speed of the substrate in at least a partial region on the surface of the substrate on the basis of the data stored in said storage unit.

### BRIEF DESCRIPTION OF THE DRAWINGS

FIGS. 1A to 1C are views showing the distributions of defects when the rotational speed of a substrate to be processed is changed in accordance with a substrate processing method according to a comparative example;

FIG. 2 is a schematic view showing the arrangement of a substrate processing apparatus according to an embodiment of the present invention;

FIG. 3 is a plan view showing water level measurement points on a substrate to be processed as an object of measurement by the substrate processing apparatus according to the embodiment; and

FIGS. 4A to 4C are graphs showing changes in water level with time at the individual measurement points shown in FIG. 3.

### DETAILED DESCRIPTION OF THE INVENTION

First, the procedure of a cleaning process according to a comparative example will be explained below.

For example, an antireflection film is formed on a 300-mm semiconductor wafer as a substrate to be processed, and the substrate is coated with a chemical amplification type resist.

An ArF excimer laser is used to perform reduced projection exposure of a desired pattern via an exposure reticle. After the substrate is annealed, a developing process is performed.

A practical method of the developing process is as follows. While a developer is discharged from a developer supply nozzle, the surface of the substrate is scanned in one direction along the radial direction from the outer peripheral region of the substrate, thereby forming a developer film on the substrate. Then, stand development is performed for a predetermined time.

Subsequently, a cleaning process using pure water and a drying process are performed. In the general rinsing/drying method, pure water is supplied from a cleaning solution supply nozzle to the central portion of the substrate for a predetermined time while the substrate is rotated. After that, while the substrate is rotated, the cleaning solution supply position is moved from the central portion to the outer periphery of the substrate by moving the cleaning solution supply nozzle, thereby extending the drying region from the central portion to the outer periphery. Finally, the cleaning solution supply position is moved to the outer periphery of the substrate. Alternatively, the substrate is dried by stopping the supply of the cleaning solution.

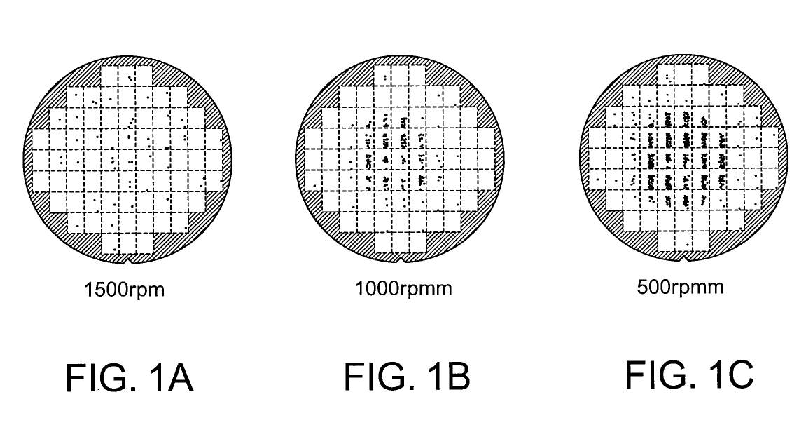

FIGS. 1A to 1C illustrate the cleaning results when the general cleaning process as a comparative example as described above is performed.

FIGS. 1A, 1B, and 1C illustrate the distributions and numbers of defects when the rotational speeds of substrates to be processed are 1,500, 1,000, and 500 (rpm), respectively, and the moving velocity of the cleaning solution supply nozzle is constant.

As is apparent from FIGS. 1A to 1C, the rotational speed of the substrate largely changes the number of defects, indicating that the cleaning method must be optimized.

Also, as described previously, even when optimization is performed for a certain resist material, an optimum solution changes when the resist material changes. This makes it difficult to perform optimization for each resist material.

A substrate processing method and substrate processing apparatus according to an embodiment of the present invention will be explained below with reference to the accompanying drawings. An object of this embodiment is a rinsing/drying process in a photosensitive resin film developing step.

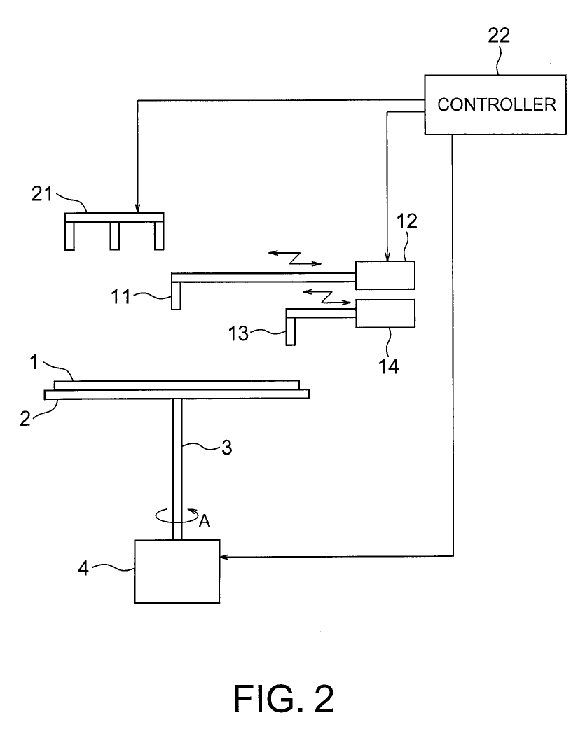

FIG. 2 shows the arrangement of the substrate processing apparatus according to this embodiment. This apparatus comprises a rotary mechanical unit including a substrate holder 2 for holding a substrate 1 to be processed, a rotational shaft 3 for rotating the substrate 1, and a driving unit 4, a developer supply nozzle 13 for supplying a developer, a moving mechanical unit 14 for moving the developer supply nozzle 13 parallel to the substrate 1, a cleaning solution supply nozzle 11 for supplying a cleaning solution, a moving mechanical unit 12 for moving the cleaning solution supply nozzle 11, a drying monitor unit 21 for measuring the drying states in a plurality of portions on the surface of the substrate 1, and a controller 22 for controlling the operations of the driving unit 4, moving mechanical units 12 and 14, and drying monitor unit 21.

The drying monitor unit 21 irradiates the substrate 1 with light having a single wavelength, and monitors the intensity of the reflected light from the substrate 1, thereby measuring the drying state, i.e., the water level of the cleaning solution existing on the substrate 1.

A procedure of performing a cleaning process in accordance with this embodiment by using the substrate processing apparatus as described above will be explained below.

After stand development is performed for a predetermined time, a pure water is supplied as a cleaning solution from the cleaning solution supply nozzle 11 to the central portion of the substrate 1 while it is rotated.

When a predetermined time has elapsed, the cleaning solution supply nozzle 11 is moved from the central portion to the outer periphery of the substrate 1 while it is rotated, thereby moving the cleaning solution supply position from the central portion to the outer periphery of the substrate, and extending the drying region from the central portion to the outer periphery of the substrate.

In this step, the drying states in a plurality of portions on the surface of the substrate 1 are measured on the basis of outputs from the drying monitor unit 21. On the basis of the measurement results, the controller 22 calculates the moving velocity of drying that extends from the central portion to the outer periphery of the substrate 1. The controller 22 then controls one or both of the rotational speed of the substrate 1 and the moving velocity of the cleaning solution supply nozzle 11, such that the moving velocity of the cleaning solution supply position matches the drying moving velocity.

For example, if the drying moving velocity obtained by the measurements is lower than a preset cleaning solution supply position moving velocity, the controller 22 decreases the moving velocity of the cleaning solution supply nozzle 11 on the basis of the measurement results so as to decrease the cleaning solution supply position moving velocity.

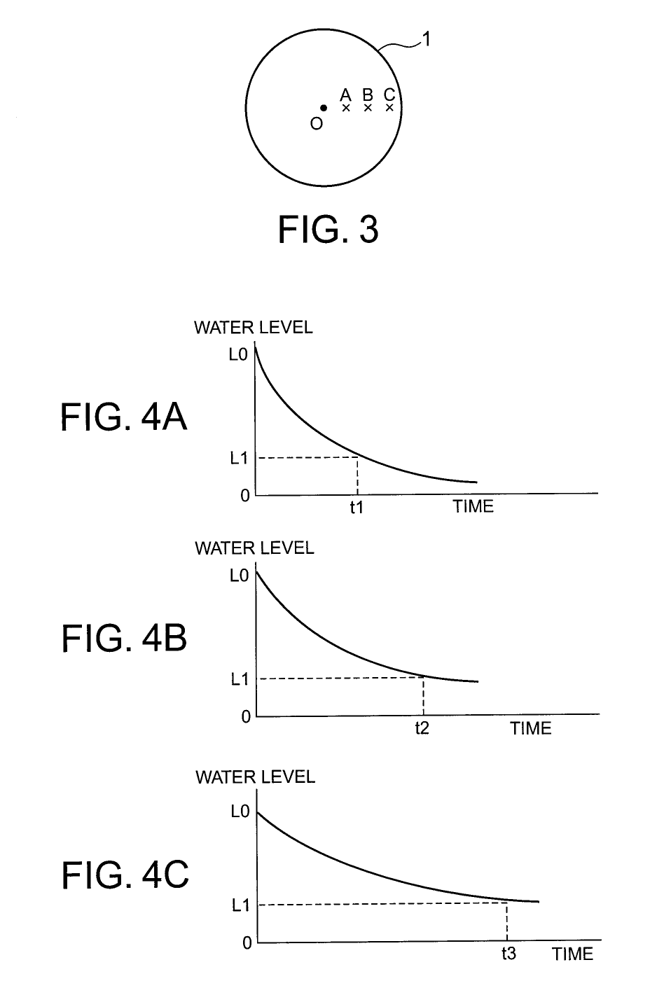

Practical drying state measurements and drying moving velocity measurements will be explained below. FIG. 3 shows measurement points A, B, and C at which the drying state is measured on the surface of the substrate 1. The measurement points A, B, and C are arranged in this order along the radial direction from a center O to the outer periphery of the substrate 1.

FIGS. 4A to 4C illustrate changes in water level at the measurement points A, B, and C. The cleaning solution supply nozzle 11 is positioned closer to the center O than the measurement points A, B, and C, and moves toward the outer periphery.

At the measurement point A as shown in FIG. 4A, the water level decreases with the passing of time, and a time t1 has elapsed before the water level reaches a predetermined level L1.

At the measurement point B as shown in FIG. 4B, a time t2 longer than the time t1 has elapsed before the water level reaches the predetermined level L1. Also, at the measurement point C as shown in FIG. 4C, a time t3 longer than the time t2 has elapsed before the wafer level reaches the predetermined level L1.

As described above, as the measurement position moves in the order of the measurement points A, B, and C from the center O to the outer periphery on the surface of the substrate 1, the cleaning solution moves to the outer periphery by rotation, and this prolongs the time required to lower the water level. Accordingly, it is only necessary to control one or both of the moving velocity of the cleaning solution supply nozzle 11 and the rotational speed of the substrate 1, such that the cleaning solution supply nozzle 11 reaches each of the measurement points A, B, and C when the water level reaches the predetermined level at the point.

Two thousand defects occurred when cleaning was performed in accordance with the comparative example described earlier, i.e., when the drying moving velocity and cleaning solution supply position moving velocity did not match. By contrast, the number of defects reduced to 60 when cleaning was performed in accordance with this embodiment while performing control such that the drying moving velocity and cleaning solution supply position moving velocity matched. In this manner, the cleaning effect of this embodiment was confirmed.

When performing control such that the drying moving velocity and cleaning solution supply position moving velocity match, the moving velocity of the cleaning solution supply nozzle 11 is controlled in this embodiment. However, it is also possible to change the rotational speed of the substrate 1 without changing the moving velocity of the cleaning solution supply nozzle 11 from the initial setting. For example, if the drying moving velocity is higher than the cleaning solution supply position moving velocity, the drying moving velocity is decreased by decreasing the rotational speed of the substrate 1. On the other hand, if the dying moving velocity is lower than the cleaning solution supply position moving velocity, the drying moving velocity is increased by increasing the rotational speed of the substrate 1.

Alternatively, it is also possible to control both the moving velocity of the cleaning solution supply nozzle 11 and the rotational speed of the substrate 1, such that the drying moving velocity and cleaning solution supply position moving velocity match.

If the measured drying moving velocity is high, i.e., if the velocity at which the water level decreases to the predetermined level from the central portion to the outer periphery of the substrate is high, it is also possible to decrease the drying moving velocity by once returning the cleaning solution supply nozzle to the center of the substrate.

If films to be cleaned are made of the same material, control can be performed by using the drying moving velocity measured when cleaning was performed before, so that the cleaning solution supply position moving velocity matches the drying moving velocity. When cleaning films made of the same material a plurality of number of times, therefore, the drying moving velocity need not be measured whenever cleaning is performed. That is, it is possible to prestore the results of measurements performed before in the controller or in an external storage unit, and read them out and use them in control when cleaning the films.

It is also possible to automatically determine whether the drying velocities of films to be cleaned are the same. For example, this determination can be performed by measuring the contact angle which a waterdrop formed on the surface of the film makes with the film surface by using a contact angle meter. It is also possible to prestore, in a storage unit, the cleaning solution supply position moving velocity optimized for each contact angle, i.e., each film material, and allow the controller 22 to perform control on the basis of this data.

In the above embodiment, an object of control is the optimization of cleaning of the entire surface of a substrate to be processed. However, as shown in FIG. 1C, control may also be performed to optimize cleaning of at least a partial region, e.g., a circular region from the center of a substrate to a predetermined radius such as 50 mm where defects easily occur.

The substrate processing method and substrate processing apparatus of the above embodiment can achieve a high cleaning effect by a simple method even when cleaning films made of different materials.

The above embodiment is merely an example and does not limit the present invention. Hence, the embodiment can be variously modified within the technical scope of the invention.

What is claimed is:

1. A substrate processing method of drying a substrate to be processed by rotating the substrate while supplying a cleaning solution onto a surface of the substrate, the method comprising,
when moving, on the substrate, a cleaning solution supply position where the cleaning solution is supplied on the surface of the substrate in rotation, measuring a water level in a predetermined portion on the surface of the substrate in at least a partial region on the surface of the substrate, and controlling based on the measured water level at least one of a cleaning solution supply position moving velocity when moving the position where the cleaning solution is supplied and a rotational speed of the substrate.

2. The method according to claim 1, wherein when supplying the cleaning solution onto the surface of the substrate in rotation, the water level is measured in a plurality of portions on the surface of the substrate, and at least one of the cleaning solution supply position moving velocity and the rotational speed of the substrate is controlled such that when the water level decreases to a predetermined level in each of said plurality of portions, the cleaning solution supply position matches the portion.

3. The method according to claim 2, wherein said plurality of portions on the surface of the substrate include at least two portions arranged along a radial direction from a center to an outer periphery of the substrate.

4. The method according to claim 3, wherein when controlling at least one of the cleaning solution supply position moving velocity and the rotational speed of the substrate, the water level is measured in a plurality of portions on the surface of the substrate, a moving velocity of drying which moves from the center to the outer periphery of the substrate is calculated on the basis of the measured water levels, and at least one of the cleaning solution supply position moving velocity and the rotational speed of the substrate is controlled on the basis of the drying moving velocity.

5. The method according to claim 4, wherein when controlling the cleaning solution supply position moving velocity or when controlling the cleaning solution supply position moving velocity and the rotational speed of the substrate, the cleaning solution supply position moving velocity, or the cleaning solution supply position moving velocity and the rotational speed of the substrate are controlled such that the cleaning solution supply position moving velocity matches the drying moving velocity.

6. The method according to claim 4, wherein when controlling the rotational speed of the substrate or when controlling the cleaning solution supply position moving velocity and the rotational speed of the substrate, the rotational speed of the substrate is controlled such that the cleaning solution supply position moving velocity matches the drying moving velocity.

7. The method according to claim 6, where when controlling the rotational speed of the substrate or when controlling the cleaning solution supply position moving velocity and the rotational speed of the substrate, the rotational speed of the substrate is controlled such that the rotational speed of the substrate is decreased if the drying moving velocity is higher than the cleaning solution supply position moving velocity, and increased if the drying moving velocity is lower than the cleaning solution supply position moving velocity.

8. The method according to claim 6, wherein when controlling the cleaning solution supply position moving velocity, or when controlling the cleaning solution supply position moving velocity and the rotational speed of the substrate, the cleaning solution supply position moving velocity is controlled such that if the drying moving velocity is higher than the cleaning solution supply position moving velocity, the drying moving velocity is decreased by once returning the cleaning solution supply position to the center of the substrate.

9. The method according to claim 1, further comprising
storing premeasured data concerning a change in water level of the cleaning solution when cleaning a predetermined film formed on the substrate, and
controlling based on the stored data at least one of the cleaning solution supply position moving velocity and the rotational speed of the substrate.

10. The method according to claim 9, wherein the data concerning the change in water level of the cleaning solution includes data concerning a contact angle which a waterdrop formed on a surface of the predetermined film makes with the predetermined film.

11. A substrate processing apparatus for drying a substrate to be processed by rotating the substrate while supplying a cleaning solution onto a surface of the substrate, the apparatus comprising:
a substrate holding/rotating unit configured to hold and rotate the substrate;
a cleaning solution supply unit configured to supply the cleaning solution onto the surface of the substrate in rotation while moving over the substrate;
a measuring unit configured to measure a water level of the cleaning solution on the surface of the substrate; and
a controller configured to control at least one of a cleaning solution supply position moving velocity and a rotational speed of the substrate on the basis of the water level of the cleaning solution measured in at least a partial region on the surface of the substrate.

12. The apparatus according to claim 11, wherein
said measuring unit measures the water level of the cleaning solution in a plurality of portions on the surface of the substrate, and
said controller controls at least one of the cleaning solution supply position moving velocity and the rotational speed of the substrate such that when the water level decreases to a predetermined level in each of said plurality of portions, the cleaning solution supply position matches the portion.

13. The apparatus according to claim 12, wherein said measuring unit is placed in at least two portions arranged along a radial direction from a center to an outer periphery of the substrate.

14. The apparatus according to claim 13, wherein when controlling at least one of the cleaning solution supply position moving velocity and the rotational speed of the substrate, said controller calculates a moving velocity of drying which moves from the center to the outer periphery of the substrate on the basis of water levels measured by said measuring unit in a plurality of portions on the surface of the substrate, and controls at least one of the cleaning solution supply position moving velocity and the rotational speed of the substrate on the basis of the drying moving velocity.

15. The apparatus according to claim 14, wherein when controlling the cleaning solution supply position moving velocity, or when controlling the cleaning solution supply position moving velocity and the rotational speed of the substrate, said controller controls the cleaning solution supply position moving velocity or the cleaning solution supply position moving velocity and the rotational speed of the substrate such that the cleaning solution supply position moving velocity matches the drying moving velocity.

16. The apparatus according to claim 14, wherein when controlling the rotational speed of the substrate or when controlling the cleaning solution supply position moving velocity and the rotational speed of the substrate, said controller controls the rotational speed of the substrate such that the cleaning solution supply position moving velocity matches the drying moving velocity.

17. The apparatus according to claim 16, where when controlling the rotational speed of the substrate, or when controlling the cleaning solution supply position moving velocity and the rotational speed of the substrate, said controller controls the rotational speed of the substrate such that the rotational speed of the substrate is decreased if the drying moving velocity is higher than the cleaning solution supply position moving velocity, and increased if the drying moving velocity is lower than the cleaning solution supply position moving velocity.

18. The apparatus according to claim 16, wherein when controlling the cleaning solution supply position moving velocity, or when controlling the cleaning solution supply position moving velocity and the rotational speed of the substrate, said controller controls the cleaning solution supply position moving velocity such that if the drying moving velocity is higher than the cleaning solution supply position moving velocity, the drying moving velocity is decreased by once returning the cleaning solution supply position to the center of the substrate.

19. A substrate processing apparatus for drying a substrate to be processed by rotating the substrate while supplying a cleaning solution onto a surface of the substrate, the apparatus comprising:
a substrate holding/rotating unit configured to hold and rotate the substrate;
a cleaning solution supply unit configured to supply the cleaning solution onto the surface of the substrate in rotation while moving over the substrate;
a storage unit configured to store premeasured data concerning a change in water level of the cleaning solution when cleaning a predetermined film formed on the substrate; and
a controller configured to control at least one of a cleaning solution supply position moving velocity and a rotational speed of the substrate in at least a partial region on the surface of the substrate on the basis of the data stored in said storage unit.

20. The apparatus according to claim 19, wherein the data concerning the change in water level of the cleaning solution stored in said storage unit contains data concerning a contact angle which a waterdrop formed on a surface of the predetermined film makes with the predetermined film.
